(19) United States
(12) Patent Application Publication
(10) Pub. No.: US 2024/0070353 A1
(43) Pub. Date: Feb. 29, 2024

(54) Automatic Design Methods For Optical Structures

(71) Applicant: THE REGENTS OF THE UNIVERSITY OF MICHIGAN, Ann Arbor, MI (US)

(72) Inventors: Haozhu WANG, Mount Prospect, IL (US); Lingjie Jay GUO, Ann Arbor, MI (US)

(73) Assignee: THE REGENTS OF THE UNIVERSITY OF MICHIGAN, Ann Arbor, MI (US)

(21) Appl. No.: 18/237,993

(22) Filed: Aug. 25, 2023

Related U.S. Application Data
(60) Provisional application No. 63/400,830, filed on Aug. 25, 2022.

(51) Int. Cl. G06F 30/27

(52) U.S. Cl. CPC G06F 30/27; G06F 2111/06

(57) ABSTRACT

A computer system includes memory hardware configured to store a multitask neural network, an optimization model, a material database, material feature vector inputs, and computer-executable instructions which include training the multitask neural network with the material feature vector inputs to generate a material structural parameter output, obtaining at least one of a target optical perception parameter and a target optical response, supplying the target optical perception parameter or target optical response and at least two of the multiple material data structures of the material database to the multitask neural network to output the at least one predicted material and the predicted structural parameter distribution, processing, by the optimization model, the predicted structural parameter distribution to generate a tuned structural parameter output, and transmitting the at least one predicted material and the tuned structural parameter output to a computing device to facilitate generation of an optical structure.

### CROSS-REFERENCE TO RELATED APPLICATIONS

This application claims the benefit of U.S. Provisional Application No. 63/400,830, filed on Aug. 25, 2022. The entire disclosure of the above application is incorporated herein by reference.

### GOVERNMENT LICENSE RIGHTS

This invention was made with government support under 1727918 awarded by the National Science Foundation. The government has certain rights in the invention.

### FIELD

The present disclosure relates to automatic design methods for optical structure materials.

### BACKGROUND

Optical structures may be used to provide color appearance to viewers, to filter or absorb light, and so on. For example, structural color may refer to a perceived color generated through the light interaction with patterned or layered optical structures. This may be more stable than colors produced from chemical pigments, and may serve as an environment-friendly alternative. However, designing the structures for producing desired colors is challenging due to the complex relationship between the optical structures and their spectral properties. Additionally, color metamerism, e.g., the possibility of different spectra corresponding to the same color perceived by human eyes, makes the relationship between the structures and the perceived color more complex because multiple different structures could have the same color appearance. Experts have designed optical structures based on the understanding of the physical properties of structures, including multilayer thin films, metasurfaces, metamaterials, and self-assembled colloidal particles, but due to the complex relationship between the structures and the generated color, the human-based design process is often slow and could lead to sub-optimal performance.

Recently, machine learning-based optical inverse design approaches have been developed to predict optical structures that can achieve user-specified properties. These inverse design methods often involve training a machine learning model such as deep neural networks or support vector machines on a curated dataset that contains a large number of datapoints mapping structural parameters to the corresponding color represented by coordinates in CIE xy or LAB color space. Although previous methods have been demonstrated for designing a wide range of colors, they require the materials constituting the optical structures to be fixed. Because the refractive index of materials affects their reflection and absorption properties, it could be challenging or even impossible to produce specific colors when the materials are not appropriately selected. Thus, screening appropriate materials for subsequent inverse design with machine learning models still requires intensive effort from human experts and is very time-consuming.

For optical multilayer thin-film design, a reinforcement learning approach addresses the material selection challenge by searching the material and thickness design space simultaneously. However, this method can only design a single color at a time because the reward function for training the reinforcement learning algorithm has to be defined for a specific color. It would be impractical when many colors need to be designed, e.g., designing a large array of reflective color pixels to reconstruct a colored picture, which would take an unacceptably long time using the reinforcement learning method.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer system includes memory hardware configured to store a multitask neural network, an optimization model, a material database, material feature vector inputs, and computer-executable instructions, wherein each material feature vector input includes at least one material structural parameter associated with an optical perception output, and wherein the material database includes multiple material data structures each including one or more material structural parameters. The system includes processor hardware configured to execute the instructions, and the instructions include training the multitask neural network with the material feature vector inputs to generate a material structural parameter output, wherein the material structural parameter output includes at least one predicted material and a predicted structural parameter distribution of the at least one predicted material. The instructions include obtaining at least one target optical perception parameter and a target optical response, supplying the at least one target optical perception parameter or target optical response and at least two of the multiple material data structures of the material database to the multitask neural network to output the at least one predicted material and the predicted structural parameter distribution for generating the at least one target optical perception parameter or target optical response, and processing, by the optimization model, the predicted structural parameter distribution to generate a tuned structural parameter output for generating the at least one target optical perception parameter or target optical response. The instructions include transmitting the at least one predicted material and the tuned structural parameter output to a computing device to facilitate generation of an optical structure including the at least one predicted material having the tuned structural parameter output.

In other features, the optical structure includes at least one of a multilayer thin film, a metasurface, a metamaterial, and self-assembled colloidal particles. In other features, the optical structure includes a multilayer thin film, and the predicted structural parameter distribution includes a thickness distribution of at least one layer of the multilayer thin film.

In other features, the at least one target optical perception parameter includes a visual color, the multilayer thin film includes at least one metal material and at least one dielectric material, and the at least one predicted material includes a metal material selected from a group comprising Au, Ag, Al, Cu, Cr, Ge, Ni, Ti, W and Zn, and a dielectric material selected from a group comprising Al₂O₃, Fe₂O₃, HfO₂, MgF₂, SiO₂, Ta₂O₅, TiO₂, ZnO, ZnS and ZnSe. In other features, the at least one predicted material includes a light absorbing material selected from a group comprising inorganic compounds and organic compounds. In other features, the multitask neural network includes a classification network configured to determine the at least one predicted material, and a mixture density network configured to determine the predicted structural parameter distribution. In other features, training the multitask neural network includes training the classification network together with the mixture density network.

In other features, the at least one target optical perception parameter is selected from an optical parameter space, and the instructions further include generating the material feature vector inputs by uniformly sampling the optical parameter space. In other features, the instructions further include generating at least one of the material feature vector inputs to include a synthetic material generated according to material structural parameters of at least two of the material data structures.

In other features, the tuned structural parameter output includes at least one of a material thickness, a diameter, a distance, a periodic pattern, a pitch, and a material shape. In other features, the at least one target optical perception parameter includes one or a filtering characteristic of an optical structure and a light absorption characteristic of an optical structure.

A method for generating optical structure material parameters includes training a multitask neural network with material feature vector inputs to generate a material structural parameter output, wherein each material feature vector input includes at least one material structural parameter associated with an optical perception output, a material database includes multiple material data structures each including one or more material structural parameters, and the material structural parameter output includes at least one predicted material and a predicted structural parameter distribution of the at least one predicted material. The method includes obtaining at least one target optical perception parameter, supplying the at least one target optical perception parameter and at least two of the multiple material data structures of the material database to the multitask neural network to output the at least one predicted material and the predicted structural parameter distribution for generating the at least one target optical perception parameter, and processing, by an optimization model, the predicted structural parameter distribution to generate a tuned structural parameter output for generating the at least one target optical perception parameter. The method includes transmitting the at least one predicted material and the tuned structural parameter output to a computing device to facilitate generation of an optical structure including the at least one predicted material having the tuned structural parameter output.

In other features, the optical structure includes at least one of a multilayer thin film, a metasurface, a metamaterial, and self-assembled colloidal particles. In other features, the optical structure includes a multilayer thin film, and the predicted structural parameter distribution includes a thickness distribution of at least one layer of the multilayer thin film.

In other features, the at least one target optical perception parameter includes a visual color, the multilayer thin film includes at least one metal material and at least one dielectric material, and the at least one predicted material includes a metal material selected from a group comprising Au, Ag, Al, Cu, Cr, Ge, Ni, Ti, W and Zn, and a dielectric material selected from a group comprising Al₂O₃, Fe₂O₃, HfO₂, MgF₂, SiO₂, Ta₂O₅, TiO₂, ZnO, ZnS and ZnSe.

In other features, the multitask neural network includes a classification network configured to determine the at least one predicted material, and a mixture density network configured to determine the predicted structural parameter distribution. In other features, training the multitask neural network includes training the classification network together with the mixture density network.

In other features, the at least one target optical perception parameter is selected from an optical parameter space, and the method further includes generating the material feature vector inputs by uniformly sampling the optical parameter space. In other features, the method further includes generating at least one of the material feature vector inputs to include a synthetic material generated according to material structural parameters of at least two of the material data structures.

In other features, the tuned structural parameter output includes at least one of a material thickness, a diameter, a distance, a periodic pattern, a pitch, and a material shape. In other features, the at least one target optical perception parameter includes one or a filtering characteristic of an optical structure and a light absorption characteristic of an optical structure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system for optical structure material selection using machine learning models.

FIG. 2 is a message sequence chart illustrating example interactions between components of the system of FIG. 1.

FIGS. 3A and 3B are graphical representations of example recurrent neural networks for generating machine learning models for automated entity field correction.

FIG. 4 is a graphical representation of layers of an example machine learning model.

FIG. 5 is a flowchart illustrating an example process for training a machine learning model.

FIG. 6 is an orthogonal view of an example optical multilayer thin film.

FIG. 7 is a flowchart depicting an example process for generating datasets for training a machine learning model.

FIG. 8 is a diagram illustrating color distribution of an example validation set in the CIE 1931 xy space.

FIG. 9 is a block diagram illustrating an example material-aware multitask mixture density network architecture.

FIG. 10 is an orthogonal view of an example optical structure including spaced silicon nanorods.

In the drawings, reference numbers may be reused to identify similar and/or identical elements.

### DETAILED DESCRIPTION

### Optical Structure Design System

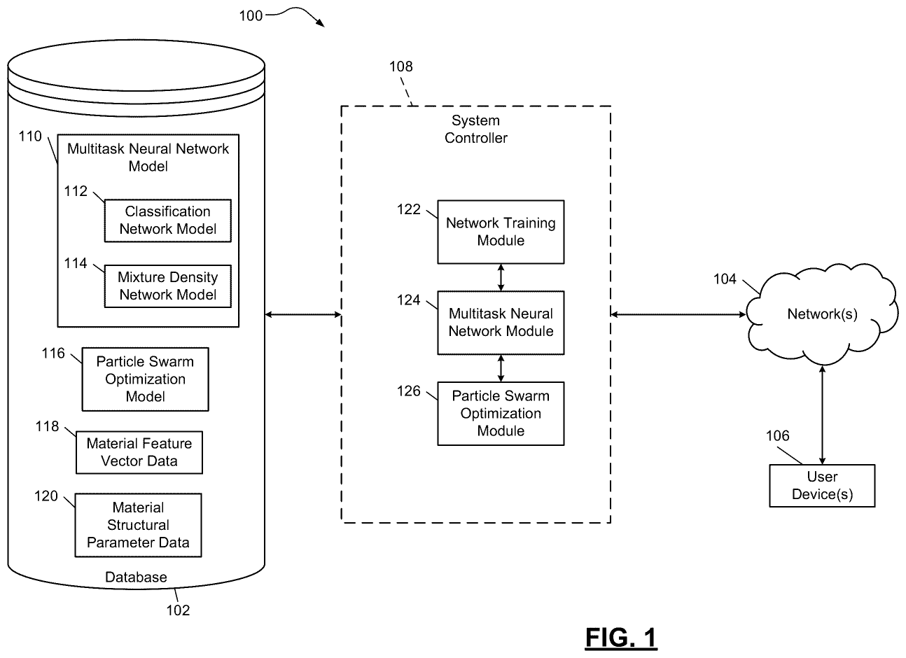

FIG. 1 is a functional block diagram of an example system 100 for automatically designing optical structure materials using machine learning models, which includes a database 102. While the system 100 is generally described as being deployed in a computer network system, the database 102 and/or components of the system 100 may otherwise be deployed (for example, as a standalone computer setup). The system 100 may include a desktop computer, a laptop computer, a tablet, a smartphone, etc.

As shown in FIG. 1, the database 102 stores one or more multitask neural network models 110 (which may include one or more classification network models 112 and mixture density network models 114), one or more particle optimization models 116, material feature vector data 118, and material structural parameter data 120. In various implementations, the database 102 may store other types of data as well. The multitask neural network model(s) 110, classification network model(s) 112, mixture density network model(s) 114, particle swarm optimization models(s) 116, material feature vector data 118, and material structural parameter data 120 may be located in different physical memories within the database 102, such as different random access memory (RAM), read-only memory (ROM), a non-volatile hard disk or flash memory, etc. In some implementations, the multitask neural network model(s) 110, classification network model(s) 112, mixture density network model(s) 114, particle swarm optimization models(s) 116, material feature vector data 118, and material structural parameter data 120 may be located in the same memory (such as in different address ranges of the same memory). In various implementations, the multitask neural network model(s) 110, classification network model(s) 112, mixture density network model(s) 114, particle swarm optimization models(s) 116, material feature vector data 118, and material structural parameter data 120 may each be stored as structured data in any suitable type of data store.

The material feature vector data 118 may include any suitable data for training one or more machine learning models, such as material structural parameters associated with optical perception outputs, material data structures each including one or more material structural parameters, electromagnetic properties associated with each material structural parameter, optical properties associated with each material structural parameter, etc. The material feature vector data 118 may be used to train one or more machine learning models to generate a material structural output, such as a prediction of a material parameter for generating a target optical perception parameter (for example, the material structural parameter output may include at least one predicted material and at least one predicted structural parameter distribution of the predicted material, which are likely to effect the target optical perception parameter if the predicted material and structural parameter distribution are implemented in an optical structure).

In various implementations, users may train a machine learning model by accessing the system controller 108 via the user device 106. The user device 106 may include any suitable user device for displaying text and receiving input from a user, including a desktop computer, a laptop computer, a tablet, a smartphone, etc. In various implementations, the user device 106 may access the database 102 or the system controller 108 directly, or may access the database 102 or the system controller 108 through one or more networks 104. Example networks may include a wireless network, a local area network (LAN), the Internet, a cellular network, etc.

The system controller 108 may include one or more modules for selecting one or more materials and structural parameters for designing an optical structure. For example, FIG. 1 illustrates a network training module 122, a multitask neural network module 124, and a particle swarm optimization module 126. The network training module may be used to train a machine learning model, such as the multitask neural network model 110 including the classification network model 112 and the mixture density network model 114.

The multitask neural network module 124 may implement, for example, the multitask neural network model 110 including the classification network model 112 and the mixture density network model 114 to generate a predicted material and a predicted structural parameter distribution of the at least one predicted material, in order to generate a target optical perception parameter. The particle swarm optimization module 126 may implement, for example, the particle swarm optimization model 116 to tune the predicted structural parameter distribution to generate a tuned optical parameter output for generating the at least one target optical perception parameter. Although FIG. 1 is described with reference to a particle swarm optimization model, other embodiments may use other suitable optimization models.

In various implementations, the multitask neural network module 124 and the particle swarm optimization module 126 may operate as a hybrid approach that combines a Material-aware Multitask Mixture Density Network (M3DN) and Particle Swarm Optimization (PSO) to predict one or more materials and structural parameters of the material(s) to create an optical structure having a target optical perception characteristic (such as a color, an optical filtering characteristic, an optical absorption characteristic, etc.).

In an example embodiment for using a multilayer thin to generate a target optical color, the multitask neural network module 124 may not search the material and thickness space simultaneously. Instead, the multitask neural network module 124 may first predict the most suitable materials and provide a diverse set of initial guesses of the thicknesses in the form of probability distributions that could fulfill the target color, then the particle swarm optimization module 126 may apply particle swarm optimization to finetune the initial thickness designs. This approach may lead to accurate and efficient inverse design for color, and example embodiments may apply the approach to many other optical design tasks where material selection and structural designs are important.

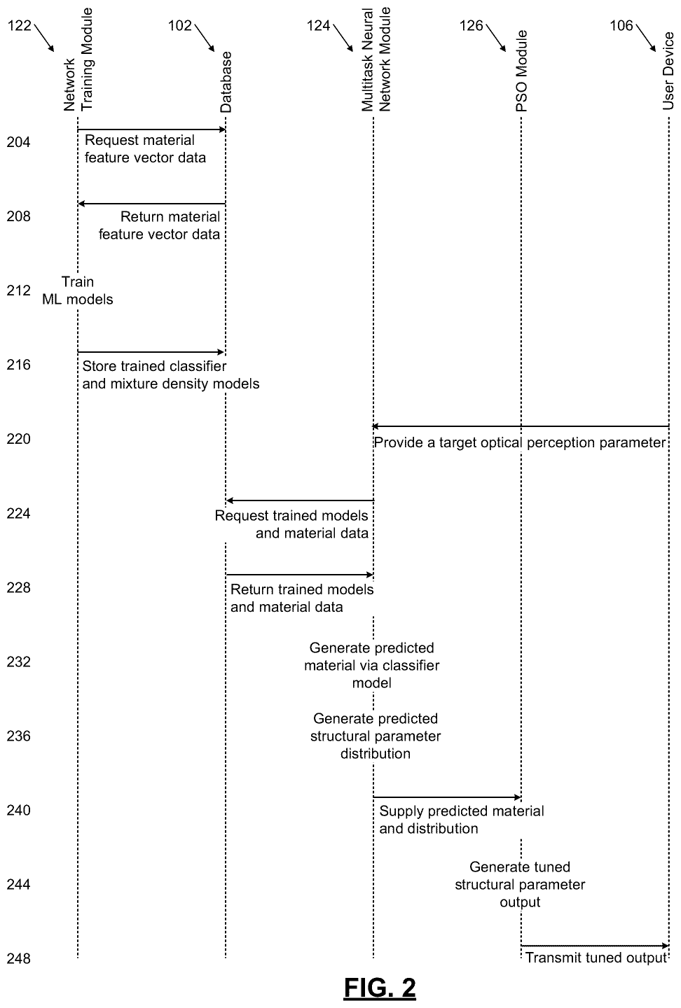

FIG. 2 is a message sequence chart illustrating example interactions between the database 102, the network training module 122, the multitask neural network module 124, the particle swarm optimization (PSO) module 126, and the user device 106. At line 204, the network training module 122 requests material feature vector data from the database 102. In various implementations, each material feature vector input may include at least one material structural parameter associated with an optical perception output. At line 208, the database 102 returns the requested material feature vector data to the network training module 122.

The network training module then trains the machine learning models at line 212. For example, the network training module 122 may use the material feature vector data 118 to train a classification network model to generate a material structural parameter output. In various implementations, the material structural parameter output may include at least one predicted material and a predicted structural parameter distribution of the at least one predicted material.

At line 216, the network training module 122 stores classifier and mixture density models in the database 102. For example, the network training module 122 may store a trained version of the classification network model 112 and a trained version of the mixture density network model 114 in the database 102 (which may be considered collectively as a trained version of the multitask neural network model 110). The classifier and mixture density models may be trained together or separately.

The user device 106 provides a target optical perception parameter and/or optical response to the multitask neural network module 124 at line 220. For example, a user may input a desired color, filtering characteristic, absorption characteristic, etc., for an optical structure, and the multitask neural network module 124 may obtain the optical perception parameter from the user device 106.

At line 224, the multitask neural network module 124 requests the trained models and material data from the database 102, and the database 102 returns the trained models and the material data at line 228. For example, multitask neural network module 124 may obtain the material structural parameter data 120 from the database 102, along with trained versions of the classification network model 112 and the mixture density network model 114. In various implementations, the material structural parameter data 120 may include multiple material data structures each including one or more material structural parameters.

The multitask neural network module 124 generates a predicted material via the trained classifier model, at line 232. For example, the multitask neural network module 124 may run the trained classification network model to output at least one predicted material for generating the target optical perception parameter and/or optical response obtained from the user device 106.

At line 236, the multitask neural network module 124 generates a predicted structural parameter distribution via the trained mixture density network model. For example, the multitask neural network module 124 may run the trained mixture density network model to output the predicted structural parameter distribution for generating the target optical perception parameter and/or optical response.

The multitask neural network module 124 supplies the predicted material and the predicted structural parameter distribution to the particle swarm optimization module 126, at line 240. For example, if the target optical perception parameter and/or optical response is a color perceived by viewing a multilayer thin film, the predicted material may include selections of materials to use for each layer of the film, and the predicted structural parameter distribution may include a distribution of thicknesses for each layer of the thin film.

At 244, the particle swarm optimization module 126 generates a tuned structural parameter output for generating the target optical perception parameter and/or optical response. For example, the PSO module 126 may perform any suitable particle swarm optimization algorithm on the predicted structural parameter distribution to generate a tuned (e.g., optimized) distribution or value for the structural parameter(s) of the predicted material.

The particle swarm optimization module 126 transmits the tuned output to the user device 106 (or any other suitable computing device) at line 248, to facilitate generation of an optical structure including the at least one predicted material having the tuned structural parameter output. For example, the tuned structural parameter output may be used to manufacture an optical structure using the predicted material(s) with structural parameters according to the tuned structural output.

### Machine Learning Models

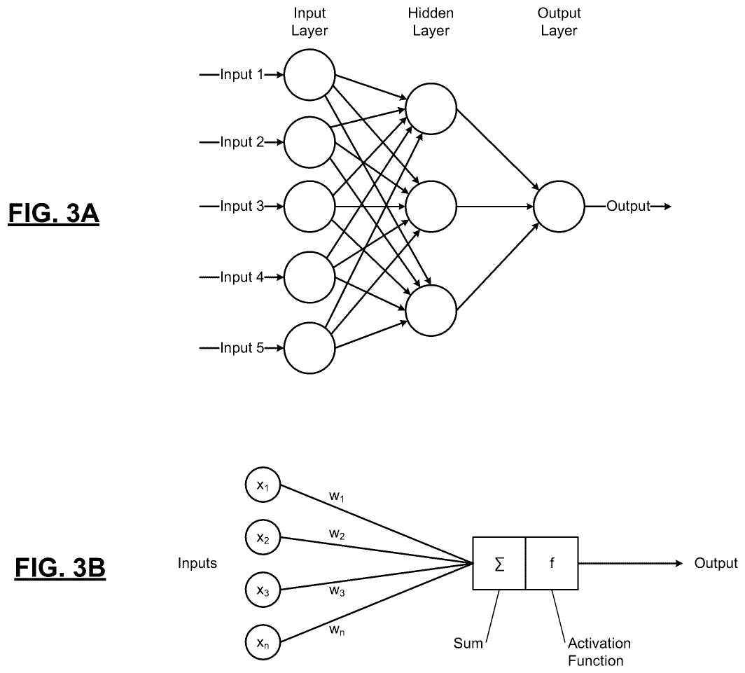

FIGS. 3A and 3B show an example of a recurrent neural network used to generate models such as those described above with reference to FIG. 1, using machine learning techniques. Machine learning is a method used to devise complex models and algorithms that lend themselves to prediction (for example, health plan customer predictions). The models generated using machine learning, such as those described above with reference to FIG. 1, can produce reliable, repeatable decisions and results, and uncover hidden insights through learning from historical relationships and trends in the data.

The purpose of using the recurrent neural-network-based model, and training the model using machine learning as described above with reference to FIG. 1, may be to directly predict dependent variables without casting relationships between the variables into mathematical form. The neural network model includes a large number of virtual neurons operating in parallel and arranged in layers. The first layer is the input layer and receives raw input data. Each successive layer modifies outputs from a preceding layer and sends them to a next layer. The last layer is the output layer and produces output of the system.

FIG. 3A shows a fully connected neural network, where each neuron in a given layer is connected to each neuron in a next layer. In the input layer, each input node is associated with a numerical value, which can be any real number. In each layer, each connection that departs from an input node has a weight associated with it, which can also be any real number (see FIG. 3B). In the input layer, the number of neurons equals number of features (columns) in a dataset. The output layer may have multiple continuous outputs.

The layers between the input and output layers are hidden layers. The number of hidden layers can be one or more (one hidden layer may be sufficient for most applications). A neural network with no hidden layers can represent linear separable functions or decisions. A neural network with one hidden layer can perform continuous mapping from one finite space to another. A neural network with two hidden layers can approximate any smooth mapping to any accuracy.

The number of neurons can be optimized. At the beginning of training, a network configuration is more likely to have excess nodes. Some of the nodes may be removed from the network during training that would not noticeably affect network performance. For example, nodes with weights approaching zero after training can be removed (this process is called pruning). The number of neurons can cause under-fitting (inability to adequately capture signals in dataset) or over-fitting (insufficient information to train all neurons; network performs well on training dataset but not on test dataset).

Various methods and criteria can be used to measure performance of a neural network model. For example, root mean squared error (RMSE) measures the average distance between observed values and model predictions. Coefficient of Determination (R²) measures correlation (not accuracy) between observed and predicted outcomes. This method may not be reliable if the data has a large variance. Other performance measures include irreducible noise, model bias, and model variance. A high model bias for a model indicates that the model is not able to capture true relationship between predictors and the outcome. Model variance may indicate whether a model is stable (a slight perturbation in the data will significantly change the model fit).

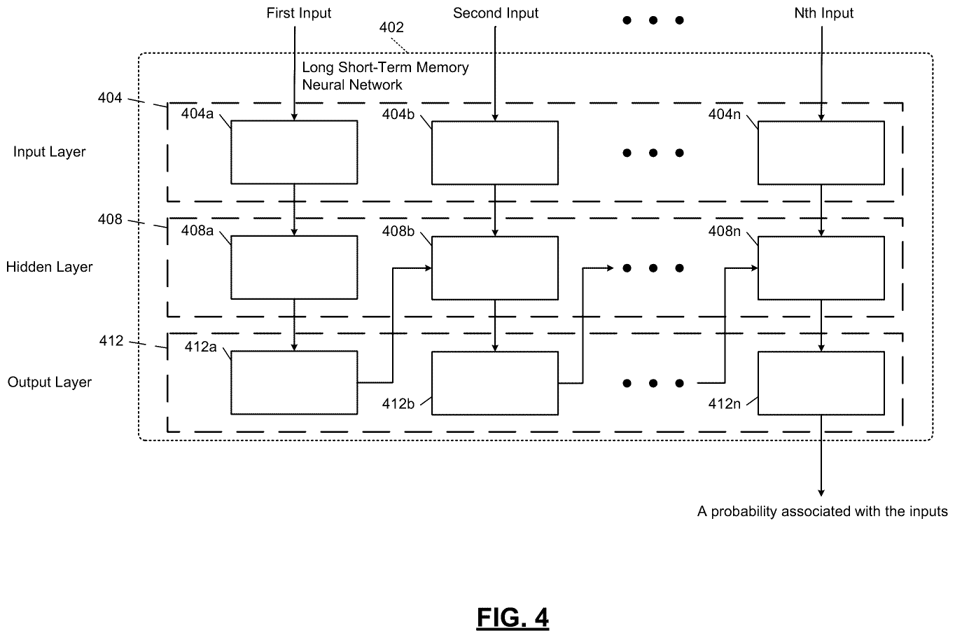

FIG. 4 illustrates an example of a long short-term memory (LSTM) neural network used to generate models such as those described above with reference to FIG. 1, using machine learning techniques. Machine learning is a method used to devise complex models and algorithms that lend themselves to prediction (for example, predicting entity field values in scanned document text of a prescription fill request). The models generated using machine learning, such as those described above with reference to FIG. 1, can produce reliable, repeatable decisions and results, and uncover hidden insights through learning from historical relationships and trends in the data.

The purpose of using the recurrent neural-network-based model, and training the model using machine learning as described above with reference to FIG. 1, may be to directly predict dependent variables without casting relationships between the variables into mathematical form. The neural network model includes a large number of virtual neurons operating in parallel and arranged in layers. The first layer is the input layer and receives raw input data. Each successive layer modifies outputs from a preceding layer and sends them to a next layer. The last layer is the output layer and produces output of the system.

FIG. 4 is a functional block diagram of a generic example LSTM neural network 402. The generic example LSTM neural network 402 may be used to implement a machine learning model, and various implementations may use other types of machine learning networks. The LSTM neural network 402 includes an input layer 404, a hidden layer 408, and an output layer 412. The input layer 404 includes inputs 404a, 404b . . . 404n. The hidden layer 408 includes neurons 408a, 408b . . . 408n. The output layer 412 includes outputs 412a, 412b . . . 412n.

Each neuron of the hidden layer 408 receives an input from the input layer 404 and outputs a value to the corresponding output in the output layer 412. For example, the neuron 408a receives an input from the input 404a and outputs a value to the output 412a. Each neuron, other than the neuron 408a, also receives an output of a previous neuron as an input. For example, the neuron 408b receives inputs from the input 404b and the output 412a. In this way the output of each neuron is fed forward to the next neuron in the hidden layer 408. The last output 412n in the output layer 412 outputs a probability associated with the inputs 404a-404n. Although the input layer 404, the hidden layer 408, and the output layer 412 are depicted as each including three elements, each layer may contain any number of elements.

In various implementations, each layer of the LSTM neural network 402 must include the same number of elements as each of the other layers of the LSTM neural network 402. In some embodiments, a convolutional neural network may be implemented. Similar to LSTM neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 404a is connected to each of neurons 408a, 408b . . . 408n.

In various implementations, each input node in the input layer may be associated with a numerical value, which can be any real number. In each layer, each connection that departs from an input node has a weight associated with it, which can also be any real number. In the input layer, the number of neurons equals number of features (columns) in a dataset. The output layer may have multiple continuous outputs.

As mentioned above, the layers between the input and output layers are hidden layers. The number of hidden layers can be one or more (one hidden layer may be sufficient for many applications). A neural network with no hidden layers can represent linear separable functions or decisions. A neural network with one hidden layer can perform continuous mapping from one finite space to another. A neural network with two hidden layers can approximate any smooth mapping to any accuracy.

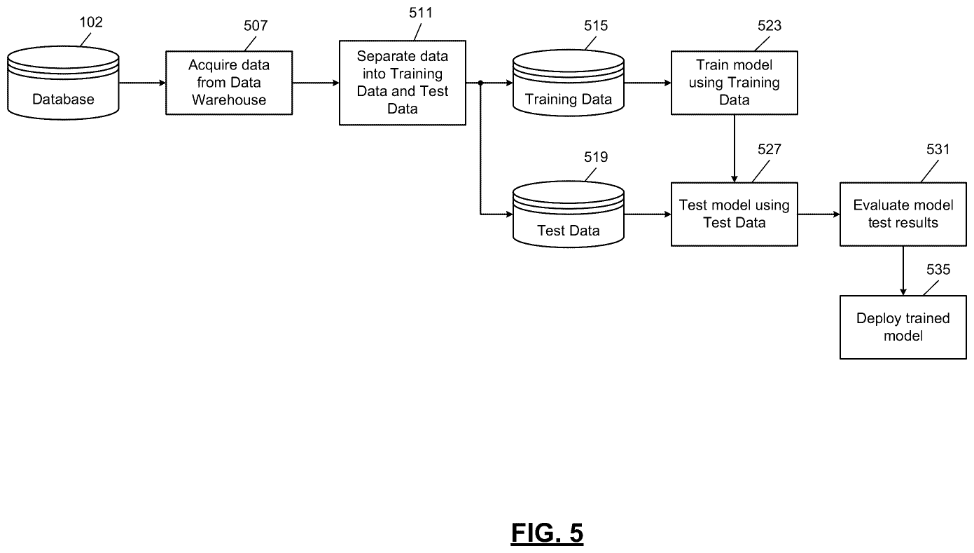

FIG. 5 illustrates an example process for generating a machine learning model (for example, using the network training module 122 of FIG. 1). At 507, control obtains data from a data warehouse, such as the database 102. The data may include any suitable data for developing machine learning models. For example, the material feature vector data 118 from the database 102 may be used as inputs for training the machine learning model.

At 511, control separates the data obtained from the database 102 into training data 515 and test data 519. The training data 515 is used to train the model at 523, and the test data 519 is used to test the model at 527. Typically, the set of training data 515 is selected to be larger than the set of test data 519, depending on the desired model development parameters. For example, the training data 515 may include about seventy percent of the data acquired from the database 102, about eighty percent of the data, about ninety percent, etc. The remaining thirty percent, twenty percent, or ten percent, is then used as the test data 519.

Separating a portion of the acquired data as test data 519 allows for testing of the trained model against actual output data, to facilitate more accurate training and development of the model at 523 and 527. The model may be trained at 523 using any suitable machine learning model techniques, including those described herein, such as random forest, generalized linear models, decision tree, and neural networks.

At 531, control evaluates the model test results. For example, the trained model may be tested at 527 using the test data 519, and the results of the output data from the tested model may be compared to actual outputs of the test data 519, to determine a level of accuracy. The model results may be evaluated using any suitable machine learning model analysis, such as the example techniques described further below.

After evaluating the model test results at 531, the model may be deployed at 535 if the model test results are satisfactory. Deploying the model may include using the model to make predictions for a large-scale input dataset with unknown outputs. If the evaluation of the model test results at 531 is unsatisfactory, the model may be developed further using different parameters, using different modeling techniques, using other model types, etc.

### Optical Color Design Examples

As mentioned above, example techniques described herein may be used to select material(s) and material parameter(s) for any suitable optical structure implementation, such as perceived color, an optical filtering characteristic, and optical absorption characteristic, etc. The following example is an optical color design process, but example embodiments of the present disclosure are not limited thereto.

In various implementations, structural color designs may be generated by first collecting training data with a wide range of colors. Next, a novel neural network model, which may be referred to as a material-aware multitask mixture density network (M3DN) may be trained on the collected dataset. For a given color design target, the material-aware multitask mixture density network may output a set of potential designs with different material combinations 127 and layer thicknesses. Subsequently, the set of initial designs may be fine-tuned with PSO to obtain the final designs with optimized material selections and layer thicknesses.

For example, a dataset for training a machine learning model may be generated by sampling (e.g., uniformly sampling) from the sRGB color target space to provide coverage of the entire color gamut (e.g., as opposed to randomly sampling structural parameters of optical structures). Particle swarm optimization may also be used to obtain datapoints, to facilitate inclusion of high-quality designs to be included in the dataset.

A novel data augmentation approach may be used (as described further below), which generates synthetic material refractive index data to broaden the input distribution, which may increase performance of the trained neural network. As mentioned above, a multitask neural network may combine both a classification network and a mixture density network for material screening and layer thickness prediction. The chosen materials and predicted thickness distributions based on the multitask neural network may be used as input for particle swarm optimization to further finetune the thickness for improved accuracy towards the color target.

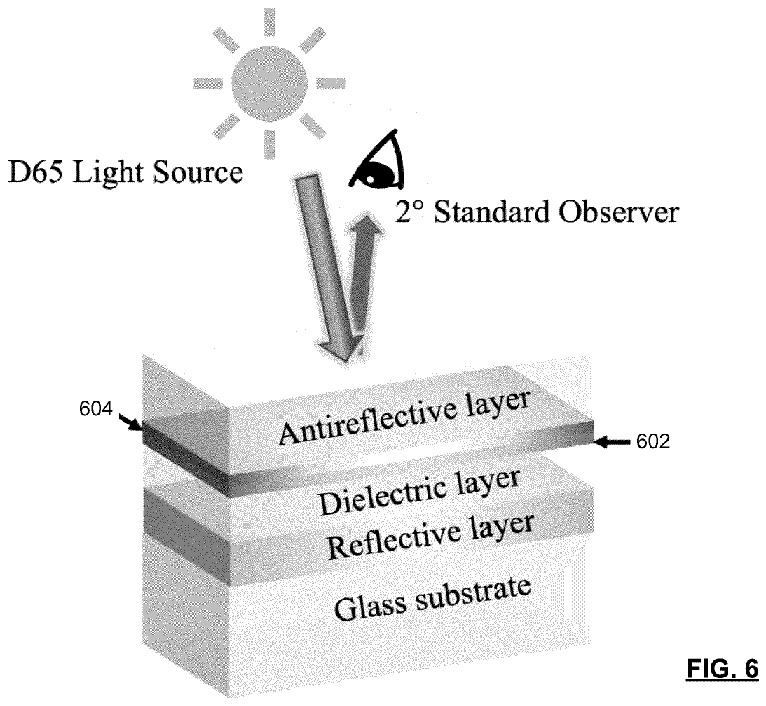

One example of a structural color material is a five-layer optical thin film as illustrated in FIG. 6, which may include two absorbing layers 602 and 604 sandwiched by two dielectric layers and a bottom metal reflecting layer. This thin film may provide high color purity and brightness, and the layers may be easily deposited by, for example, physical vapor evaporation.

In view of the high performance and feasibility for large-scale fabrications of such structures, a dataset with diverse designs based on the same five-layer structural template may be generated by varying the material and thickness of each layer. In various implementations, each thin film design may be based on randomly sampled materials from candidate metal materials (e.g., Au, Ag, Al, Cu, Cr, Ge, Ni, Ti, W, Zn), dielectric materials (Al₂O₃, Fe₂O₃, HfO₂, MgF₂, SiO₂, Ta₂O₅, TiO₂, ZnO, ZnS, ZnSe), organic compounds, in organic compounds, etc. Other embodiments may include more or less candidate materials, more or less dielectric materials, other kinds of materials, etc.

For example, in various implementations a multi-layer design may be based on dielectric materials without metals, which may be an important class of multi-layer designs for structural color and optical filter designs. For example, a multilayer thin film may include at least one first dielectric material, and at least one second dielectric material having a different refractive index. In some example embodiments, the at least one predicted material may include a dielectric material selected from a group comprising Si, Ge, Al₂O₃, Fe₂O₃, HfO₂, MgF₂, SiO₂, Ta₂O₅, TiO₂, ZnO, ZnS and ZnSe (and may include multiple dielectric materials having different refractive indexes).

In some example embodiments, the absorber layers 602 and 604 and the bottom reflective layer may be composed of metals, while the other two layers are based on dielectric materials. Including a wide range of candidate materials with different refractive indices may facilitate searching for the most suitable materials combinations for specific color targets.

When sampling the materials for the two absorbing layers 602 and 604, a constraint may be introduced where the two adjacent absorber layers 602 and 604 are composed of different materials, instead of using simply a single absorber material with a higher thickness that may not satisfy a design requirement. In this example, the total number of unique material combinations of the five-layer stack may be 10×10×9×10×10=9×10⁴.

Because sRGB is widely used in display industry design and production, some models may strive to provide the best coverage over the sRGB color gamut. Randomly sampling layer thicknesses from a specified range to generate data points with different designs and color properties may lead to non-uniform coverage in the color space, e.g., the density of data points in a certain color region may be higher than other regions in the color space.

Because non-uniform data coverage may lead to an undesirable skewed inverse design performance where an inverse design model is more accurate for the color regions with more data points, some example embodiments may directly sample from the color target space uniformly. For example, instead of randomly sampling the thicknesses of the layers, some example embodiments may randomly sample the sRGB color target from the 3D sRGB space with a value range of [0, 255] for each dimension.

For each randomly sampled material combination and color target pair, particle swarm optimization may be used to improve (e.g., optimize) the thickness of the top four layers to reduce or minimize a color difference between the color of the designed structure and the color target, while fixing the bottom reflective layer at 100 nm (or a smaller or greater thickness).

Particle swarm optimization is a global optimization algorithm for optical designs. When solving a reduction or minimization problem, PSO maintains a group of particles (i.e., solutions) that individually explore the solution space and communicate with each other to share information about the explored solution space. Positions of all particles may be iteratively updated based on the best solution each particle has found, and the best solution found by the entire group until a convergence criterion is met. In the five-layer optical thin film design example, each particle's “position” may be a 4D vector corresponding to thicknesses of the top four layers of the thin film. The final position all particles converge to may be the final thickness design obtained through PSO.

Throughout the optimization process, the reflection spectrum of multilayer designs may be computed using, e.g., a transfer matrix method for the wavelength range [400, 700] nm, with a step size of 10 nm. Thus, each material's complex refractive index may be described by a 62-dimensional vector for each of the 31 wavelength points.

In various implementations, the Python package Colour may be used for the conversion of reflection spectrum to sRGB and Lab color coordinates. The industry-standard CIEDE2000 metric may be used based on Lab coordinates to measure the color difference between the target color and the color obtained through the designs.

After the particle swarm optimization converges, if the CIEDE2000 for the given material combination and the color target is lower than or equal to 2, it may be considered that the specific material combination allows accurate generation of the target color because a CIEDE2000 value ≤2 may be almost imperceivable by untrained eyes. A label e=1 may be assigned if the CIEDE2000 value ≤2, otherwise the label may be e=0.

In some example embodiments, the Lab color coordinates and the sRGB coordinates for the same design may have a one-to-one correspondence, and so it may be possible to compute the CIEDE2000 value only using only the Lab color coordinates. In contrast, sRGB coordinates may be used as the color target. If users need to design specifically for a given Lab or CIE xy target, sRGB coordinates can be uniquely obtained from the provided color coordinates defined on other color spaces.

In various implementations, the thickness of each layer may be set as the thickness range for both dielectric layers from the range [5, 250] nm, and the thickness of the absorbing layers to be in the range [5, 15] nm during the particle swarm optimization process. The thickness of the bottom metal layer may be fixed to be 100 nm (or more or less) because it is used as a reflector, whose thickness may have a negligible effect on the reflective color as long as the layer is thick enough to reflect the light completely.

Additionally, the thicknesses of all layers may be constrained to be integers, to allow ease of optical structure fabrications. Thus, the size of the design space after considering variations in materials combinations and thickness designs may be 9×10⁴×11²×246²=6.6×10¹¹.

In various implementations, a smaller number of primitive materials that may otherwise limit an amount of variations in refractive index data may be compensated via augmenting the dataset by randomly mixing, e.g., two dielectrics or two metals to form synthetic dielectric or metal composite materials, in order to broaden the training dataset distribution through convex combination of their complex refractive indices. For example, the mixture of two thin material layers may be considered as a linear combination of the two materials, and may be helpful to improve color purity. An example formula for obtaining a complex refractive index is:

nᵢ=βᵢ·n_{M1,i}+(1−βᵢ)·n_{M2,i}

where M_{1,i} and M_{2,i} are two sampled materials for ith layer, βᵢ˜(0, 1) is the mixing factor for the ith layer, n_{M1,i}, n_{M2,i}, and n, are the complex refractive indices for two randomly selected primitive materials and the composite material synthesized from them for the ith layer. In some implementations, the composite material refractive index may be synthetic and may not be experimentally achievable. The composite material refractive index may serve as additional data to improve the data variation so a machine learning model can learn more efficiently from the data.

In one example embodiment, a total of 400,000 data points were generated, and about half of the samples were based on primitive (e.g., actual) materials while the others were based on synthetic materials via linear superposition. The entire dataset was randomly split into, e.g., 380,000/10,000/10,000 data points for training/validation/testing. In various implementations, both the validation and test sets may be based on primitive materials only, to study the model's design accuracy for designs based on attainable actual materials, and mixtures of materials may only be introduced in the training set for the purpose of data augmentation.

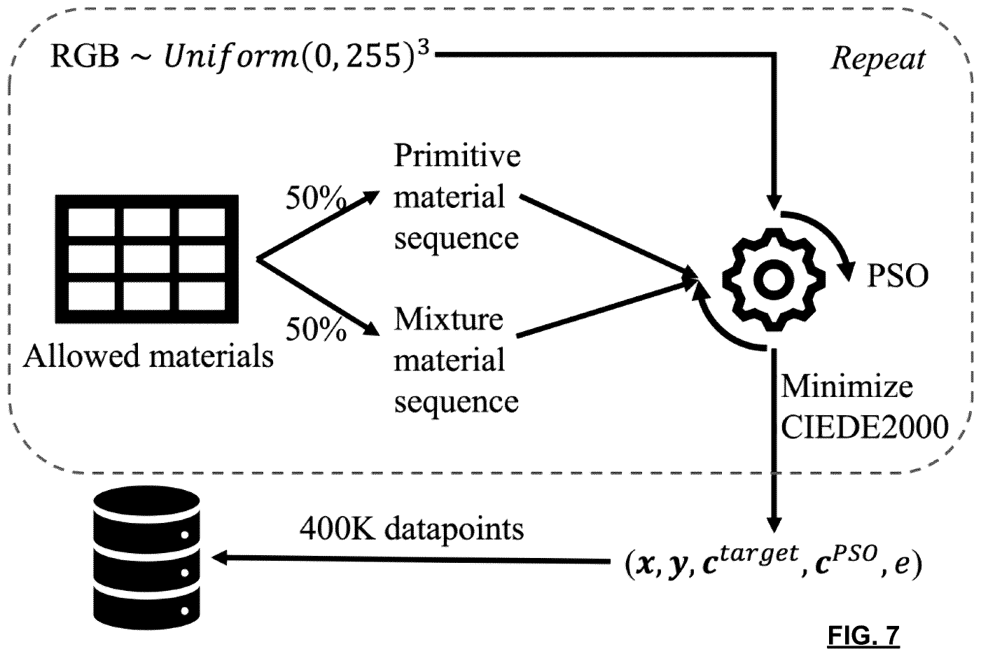

Each data point (x, y, c^{target}, c^{PSO}, e) may be a tuple comprised of the refractive index data for all five layers concatenated as a single vector x with 310 dimensions (e.g., each material's complex refractive data may be a 62-dimensional vector), the thickness of the top four layers y obtained with PSO, the target color sRGB color c^{target}, the obtained color through PSO c^{PSO}, and the binary label e∈[0, 1] indicating whether the CIEDE2000 between c^{target} and c^{PSO} is smaller than or equal to 2 (or higher or lower values). Continuous variables (x, y, c^{target}, c^{PSO}) may be transformed to the range [−1, 1] (or any other suitable range). A pictorial illustration of the full data generation pipeline is illustrated in FIG. 7.

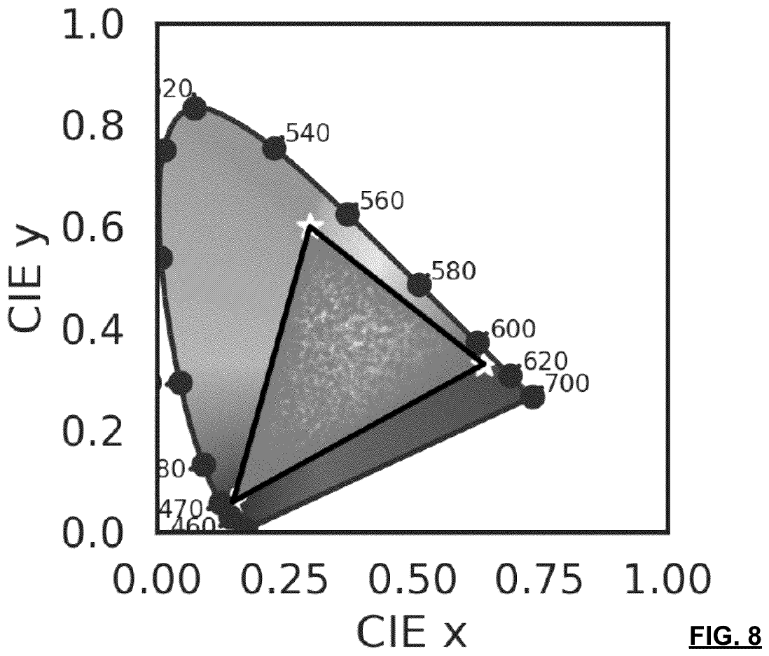

FIG. 8 illustrates an example color distribution of a validation set visualized in a CIE 1931 xy space. The data points achieve a good coverage of the entire sRGB color gamut spanned by standard Red, Blue and Green colors. FIG. 6D illustrates randomly sampled RGB color targets, and RGB colors obtained through particle swarm optimization.

In various implementations, the multitask neural network module 124 and the particle swarm optimization module 126 may be used to design an optical structure for a single target color. For example, an environmental-friendly five-layer optical thin film stack with an appearance similar to chrome may potentially replace the traditional highly toxic chrome plating process that poses great dangers to both workers and the environment. Thus, it is highly desirable to develop alternative solutions that can produce the chrome appearance but do not require the dangerous chrome plating process.

In this example, Cr was excluded from the available metals, and the model predicted the likelihood pΔE₀₀≤2(c_{target}|x) for all 10×9×8×10×10=720,000 possible material combinations. In particular, the target RGB value of Chromium, and all allowed material combinations, may be supplied to the multitask neural network module 124 to screen for materials by ranking the top combinations based on pΔE₀₀≤2 values.

Next, the top combinations (e.g., the top combinations having the largest likelihoods of generating the target color) may be supplied from the multitask neural network module 124 to the particle swarm optimization module 126 to minimize the ΔE₀₀ values via a PSO algorithm. Details of example designs, and the CIEDE2000 values for each design using only the multitask neutral network module, and also after adding PSO fine-tuning by the PSO module 126 (in bold), are show in Table 1 below. All five of the top final designs obtained CIEDE2000 values lower than two, and were therefore highly promising for replacing the traditional Cr plating process with the environmental-friendly thermal evaporation process.

TABLE 1
Chrome color designs based on M [symbol] DN only
and the fine-tuned design by PSO (bold).

| | A [symbol] reflective | Absorber | Absorber | Dielectric | Reflective | |
|---|---|---|---|---|---|---|
| | Layer | Layer I | Layer II | Layer | Layer | |
| Design | (nm) | (nm) | (nm) | (nm) | (nm) | ΔE₀₀ |
| I | H [symbol] O₂ | W | [symbol] | SiO₂ | Zn | 7. [symbol] /0. [symbol] |
| | 120/105 | 13/15 | 15/10 | 122/ [symbol] | 100/100 | |
| II | H [symbol] O₂ | Zn | [symbol] | Al₂O [symbol] | N [symbol] | 15.8/1.2 |
| | 12/7 | 14/14 | 8/13 | 1 [symbol] 0/9 [symbol] | 100/100 | |
| III | SiO [symbol] | Ag | [symbol] | SiO₂ | Au | 9.8/1.4 |
| | 273/250 | 14/14 | 1 [symbol] /15 | 1 [symbol] 7/130 | 100/100 | |
| IV | H [symbol] O₂ | Zn | [symbol] | Al [symbol] O [symbol] | Au | 25.0/1. [symbol] |
| | 61/5 | 14/14 | 15/15 | 202/207 | 100/100 | |
| V | H [symbol] O₂ | Zn | [symbol] | MgF₂ | Au | [symbol] .4/1. [symbol] |
| | 97/93 | 15/15 | 12/11 | 2 [symbol] 9/218 | 100/100 | |

[symbol]

indicates data missing or illegible when filed

As another example, the multitask neural network module 124 and the particle swarm optimization module 126 may be used to design optical thin film structures for a large set of color targets, such as picture reconstruction. Because many high-resolution pictures have a large number of pixels with unique sRGB values, which could take a long time to design when the PSO fine-tuning step is involved, pixel values may be quantized. In various implementations, a quantization step size of 10 may reduce the number of unique pixels of a full-color picture by more than ˜50× while maintaining the quality of the original pictures with, e.g., more than ˜200,000 pixels.

In this example, the target RGB values of the quantized picture may be supplied to the multitask neural network module 124 along with allowed material combinations. The multitask neural network module 124 may then compute an average pΔE₀₀≤2 over the entire picture to be reconstructed, to rank the best material combinations. These top ranked material combinations are then supplied from the multitask neural network module 124 to the particle swarm optimization module 126 to minimize the average ΔE₀₀ values via a PSO algorithm.

The same material combination may be selected for all pixels across the entire picture to make fabrication possible through grayscale lithography. Example average pΔE₀₀≤2 distributions for all allowed material combinations indicated that only a few material combinations may lead to high success in average design accuracy, and demonstrated the importance of the material classification network. Again, PSO may significantly improve the average design accuracy compared to the output of the multitask neural network module 124 alone.

In various implementations, example models described herein may be applied to pictures obtained through neural style transfer, such as a computer vision method that can transform images to possess an appearance similar to a style source image. In some example embodiments, the top four layers' thickness may be optimized to obtain designs across the entire picture. Although the same material combination may be selected for an entire picture with the feasibility of fabrication in mind, it may still be challenging in practice to use different thickness for each layer at each pixel in the picture. In some example embodiments, picture reconstruction may be performed where only the bottom dielectric layer is varied while all other layers' thickness is fixed. Therefore, when fabrication-friendly designs are preferred over design accuracy, the model may be used to vary a single layer for picture reconstruction.

### Additional Model Details

In various implementations, example models described herein may achieve exceptional design accuracy efficiently through combining a material classification network, a mixture density network (e.g., for material structural parameter predictions, such as thickness), and particle swarm optimization finetuning. Unlike methods that either assume fixed materials, or search the materials and thickness designs simultaneously, in various implementations the material selection and structural parameter design portions may be separated into two stages to enable an approach that can search for the best materials and design the structural parameters accordingly in an efficient manner.

Splitting the design of the material selection and the structural parameter (e.g., thickness) prediction can be helpful due to the fact that the entire design space is much larger than the material design space or the thickness design space alone. In the five-layer optical thin film design example task, the material design space size is 9×10⁴, and the thickness design space size is 7.3×10⁶, which leads to a larger full design space with a size of (9×7.3)×10¹⁰=6.3×10¹¹ when considering the material design space and the thickness design space simultaneously.

With a two-step process, promising material combinations may first be narrowed down with the material classification model (such as the classification network model 112), and only optimizing the thickness predictions (or other structural parameters) for the selected smaller set of materials. In that example, the design space for consideration may be one or a multiple of the thickness design space, which may be a ˜10,000× complexity reduction compared to searching both materials and thickness in one step.

In various implementations, the multitask neural network model and particle swarm optimization model may be combined by initializing the particle positions with designs sampled from the mixture density network. PSO may significantly improve initial solutions output by the multitask neural network model (such as the multitask neural network model 110 of FIG. 1). For example, PSO may include iterative updates of the design parameters based on feedback from optical simulations. Additionally, the exceptional design accuracy after fine-tuning the initial multitask neural network model designs with PSO may indicate that probabilistic machine learning models that can output diverse predictions are highly compatible with PSO, which may require an initial population of designs to begin with.

In some example embodiments, a strong degree of one-to-many mapping may exist for the problem of inverse designing a structural color with a five-layer optical stack. Therefore, a large number of mixture components (e.g., 51,200 or more or less), may be used to obtain an accurate inverse prediction of the designs. Although GPU memory may limit increases to the number of mixture components, design accuracy may improve as the number of mixture components is increased further.

In various implementations, optical inverse design models described herein may leverage task relationships by learning main and auxiliary tasks simultaneously. For example, varying the classification loss weight α, may provide an optimal inverse design performance at α=5 (or more or less). In optical design problems, many tasks may be related, such as the electric field distribution prediction, far-field intensity prediction, spectrum prediction, color prediction, etc. Learning multiple tasks simultaneously may facilitate obtaining high inverse design accuracy with fewer data points. In some example embodiments, data augmentation that increases the refractive index data variation by mixing primitive materials may be an efficient strategy to improve the inverse design accuracy for training material-aware inverse design models.

In various implementations, a classification model and a probabilistic regression model may be combined, and particle swarm optimization may be used for fine-tuning the designs predicted by the combined models. For example, a material-aware inverse design algorithm may combine a multitask mixture density network and particle swarm optimization to select an optimal material combination and optimize structural parameters. Although structural color design examples for multilayer optical thin film examples are presented herein, the example models may be used for any suitable optical design task that includes optimizing material selections and structural parameters.

A mixture density network (MDN) may map an input to a probability density function, e.g., of a multivariate Gaussian Mixture with m isotropic Gaussian mixture components. Because each Gaussian mixture component can learn a different mean and standard deviation value, MDNs may be able to learn a one-to-many mapping, which may be important for solving the often inverse design problems with non-unique solutions. An example probability density function given by a Gaussian mixture for a pair of refractive data input, thickness design, and corresponding color (x, y, c) may be written as:

$$p ( y \vert x , c ) = {\sum }_{j = 0}^{m - 1} {π}_{j} ( x , c ) {p}_{j} ( y \vert x , c ) = {\sum }_{j = 0}^{m - 1} {π}_{j} \frac{1}{{( 2 π )}^{\frac{D}{2}} {\prod }_{d = 0}^{D - 1} {σ}_{j , d} ( x )} {e}^{- ( {\sum }_{d = 0}^{D - 1} \frac{{( {y}_{d} - {μ}_{j , d} ( x ) )}^{2}}{2 {σ}_{j , d}^{2} ( x )} )}$$

where π(x), μ(x), σ(x) are the mixing weights, mean, and standard deviation output by the MDN with the input refractive data x and the color target c. D is the dimension of the design parameter vector y, which may be equal to 4 (or more or less) in example design problems described herein. In various implementations, the mixing weights may sum up to one so that the mixed function p(y|x,c) is a proper probability density function.

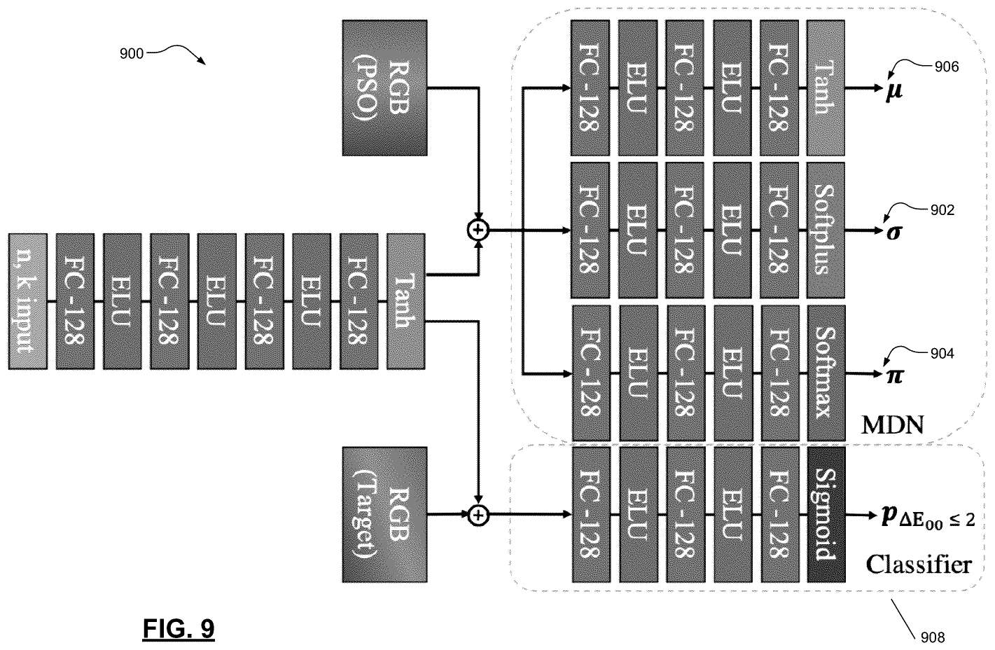

In addition to predicting the thickness, example models may also predict whether a given refractive index data x can lead to accurate designs for a target color c with CIEDE2000≤2 (i.e., ΔE₀₀≤2) after the thickness of each layer has been optimized. For example, a sub-network may form a material-aware multitask mixture density network (M³DN) that is composed of a mixture density network and a classification network, as shown in FIG. 9. In order to train the material-aware multitask mixture density network, the following example multitask loss function may be minimized:

$${ℒ}_{{M}^{3} DN} = {\sum }_{i = 0}^{N - 1} - log p ( {y}_{i} \vert {x}_{i} , {c}_{i}^{PSO} ) + α \cdot BCE ( {e}_{i} , {p}_{Δ {E}_{00} \leq 2} ( {x}_{i} , {c}_{i}^{target} ) )$$

where the first term on the right hand side is the negative log likelihood for where the first term on the right hand side is the negative log likelihood for training the MDN, and the second term is the binary cross entropy loss for training the classifier, e.g.:

BCE(eᵢ,p_{ΔE}_{₀₀}_{≤2}(xᵢ,cᵢ^{target}))=−eᵢ·log p_{ΔE}_{₀₀}_{≤2}(xᵢ,cᵢ^{target})−(1−eᵢ)·log(1−p_{ΔE}_{₀₀}_{≤2}(xᵢ,cᵢ^{target}))

In various implementations, the hyperparameter α in the material-aware multitask mixture density network (such as the multitask neural network model 110 of FIG. 1) may control the knowledge sharing among the material screening task and the thickness prediction task. In some example embodiments, cᵢ^{target} may be used as input for training the MDN while cᵢ^{PSO} is used as input for training the classifier, because the thickness yᵢ corresponds to cᵢ^{PSO}, which could differ slightly from the cᵢ^{target} in the generated dataset because PSO may only be able to find solutions with a color coordinate slightly different from the target color, e.g., cᵢ^{PSO}=cᵢ^{target}+δᵢ.

FIG. 9 illustrates an example material-aware multitask mixture density network 900. The network 900 is a seven-layer neural network with four separate output heads, although other example embodiments may include more or less layers and more or less output heads.

A softplus activation function may be used for the σ output head 902 to ensure the standard deviation prediction is always greater than 0, and a softmax activation function may be used for the mixing weight π output head 904 so that all mixing weights sum up to 1. In various implementations, ELU activations may be used for all other layers except the last layer in the base network and the output layer for the μ output head 906, where tanh may be used to ensure their outputs are in the range [−1, 1].

An advantage of training a single multitask network for both classification and thickness (or other structural parameter) prediction tasks that the classification module 908 allows users to screen among possible material combinations to select those that could lead to an accurate generation of the target color. Also, training a single multitask network may facilitate improved sample efficiency through sharing knowledge among the related classification and thickness prediction tasks.

Based on the downstream task, the material screening module 908 can be used in various ways, such as with predicted probabilities pΔE₀₀≤2. For example, when the goal is to select the best material corresponding to a single color (such as the above example searching for a chrome color replacement), the top K material combinations with the best pΔE₀₀≤2 among all possible combinations may be chosen for further examinations of their performance. When there is a set of target colors to produce (such as the above example of reproducing a color picture), the average pΔE₀₀≤2 over the set of target colors can be computed for ranking and selecting the material combinations.

Given the selected materials, the thickness (or other material structural parameter) designs may be predicted based on the color target and the material index data. However, since the output of the mixture density network is probabilistic, it is possible that the thickness output by the trained mixture density network does not correspond to the optimal value. This may be addressed by further finetuning the designs with PSO.

In various implementations, for each material combination, a specified number of structural parameter designs (such as 32 thickness designs) may be randomly selected from the MDN to be used as the initial positions of the particle swarm optimization. Then optimization may be performed until any suitable convergence, such as convergence with a tolerance level of 1×10⁻⁵.

In each optimization iteration, the designs may be evaluated through a transfer matrix method, and compared with a target spectrum. Compared to randomly initializing the positions of the particles, starting with designs sampled from the MDN may allow the PSO process to find better solutions. While conventional PSO processes may require the materials to be provided by the user, example models herein may predict the best materials to be used with the PSO. Because the manual material screening process could be time-consuming, using example models described herein may significantly speed up the entire design process by directly predicting the best materials, leading to faster, more efficient and accurate material and structural parameter design of optical structures.

### Additional Model Use Cases

In various implementations, example models described herein may be used to predict materials and structural parameters for various optical targets, such as optical filtering characteristics, optical absorption characteristics, etc. For example, an ultra-wideband absorber may be designed for a wavelength range, such as (400, 2000) nm, or any other suitable range.

A target spectrum may be chosen as, e.g., a constant 100% absorption under a normal light incidence angle (e.g., the light is shining at the absorber at a right angle) to represent an ideal broadband absorber. In some example embodiments, broadband absorption may be achieved by overlapping multiple absorption resonances and with an overall graded-index structure to minimize reflection. For example, the mixture density network may be used to predict materials and structural parameters for a 5-layer structure that optimizes average absorption under normal incidence.

Another example use case may include an incandescent light bulb filter. For example, a machine learning model such as those described herein may be used to design an optical structure filter that can enhance the luminous efficiency of incandescent light bulbs.

In various implementations, an optical structure maybe designed by a model to reflect the infrared light emitted by the light bulb filament so that its energy can be recycled. For example, a model may be used to predict materials and structural parameters for generating a target reflectivity of the optical structure to be, e.g., 0% in a first range such as (480, 700) nm, and e.g., 100% outside the range. In this manner, the infrared light, which may not contribute to lighting, may be reflected back to heat up the emitter. Performance of the optical structure filter may be quantitatively evaluated by calculating, e.g., the enhancement factor for visible light (400-780 nm) under a fixed operating power.

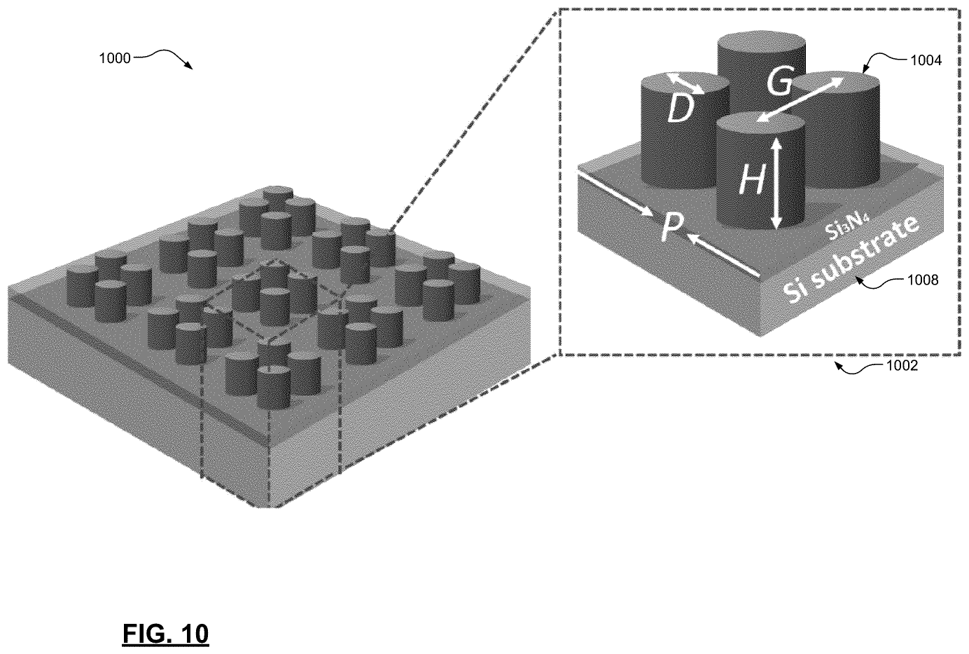

Although multilayer thin films are described in some example embodiments, various implementations may use any suitable optical structures. For example, FIG. 10 illustrates a template structure 1000 where a unit cell 1002 is arranged periodically, and the unit cell 1002 includes four identical and uniformly spaced silicon nanorods 1004. Other embodiments may include other arrangements of the nanorods and unit cells, more or less nanorods and unit cells, other materials for the nanorods, etc.

In the example of FIG. 10, a layer of 70 nm Si₃N₄ is located between the nanorod structures and the bottom silicon substrate layer 1008. This periodic template structure may be represented by a vector with four structural parameters (D, H, G, P), where D and H refer to the diameter and height of each nanorod, respectively, G refers to the gap between two nearby nanorods, and P refers to the period of the unit cell.

In various implementations, a machine learning model such as the example embodiments described herein may be used to predict structural parameters of the template parameter to generate a target optical characteristic. For example, the model may predict values for one or more of the parameters D, H, G, and P of the unit cell 1002. Other example parameters may include, but are not limited to, periodic pattern, pitch, size and shape, thickness, etc.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer system comprising:
memory hardware configured to store a multitask neural network, an optimization model, a material database, material feature vector inputs, and computer-executable instructions, wherein each material feature vector input includes at least one material structural parameter associated with an optical perception output, and wherein the material database includes multiple material data structures each including one or more material structural parameters and at least one of an electromagnetic property and an optical property associated with each material structural parameter; and
processor hardware configured to execute the instructions, wherein the instructions include:
training the multitask neural network with the material feature vector inputs to generate a material structural parameter output, wherein the material structural parameter output includes at least one predicted material and a predicted structural parameter distribution of the at least one predicted material;
obtaining at least one of a target optical perception parameter and a target optical response;
supplying the at least one target optical perception parameter or target optical response and at least two of the multiple material data structures of the material database to the multitask neural network to output the at least one predicted material and the predicted structural parameter distribution for generating the at least one target optical perception parameter or target optical response;
processing, by the optimization model, the predicted structural parameter distribution to generate a tuned structural parameter output for generating the at least one target optical perception parameter or target optical response; and
transmitting the at least one predicted material and the tuned structural parameter output to a computing device to facilitate generation of an optical structure including the at least one predicted material having the tuned structural parameter output.

2. The system of claim 1, wherein the optimization model is a particle swarm optimization model.

3. The system of claim 1, wherein the optical structure includes at least one of a multilayer thin film, a metasurface, a metamaterial, and self-assembled colloidal particles.

4. The system of claim 1, wherein:
the optical structure includes a multilayer thin film; and
the predicted structural parameter distribution includes a thickness distribution of at least one layer of the multilayer thin film.

5. The system of claim 4, wherein:
the at least one target optical perception parameter or target optical response includes a visual color;
the multilayer thin film includes at least one first dielectric material and at least one second dielectric material having a different refractive index than the first dielectric material; and
the at least one predicted material includes a dielectric material selected from a group comprising Si, Ge, Al₂O₃, Fe₂O₃, HfO₂, MgF₂, SiO₂, Ta₂O₅, TiO₂, ZnO, ZnS and ZnSe.

6. The system of claim 4, wherein:
the at least one target optical perception parameter or target optical response includes a visual color;
the multilayer thin film includes at least one metal material and at least one dielectric material; and
the at least one predicted material includes a metal material selected from a group comprising Au, Ag, Al, Cu, Cr, Ge, Ni, Ti, W and Zn, and a dielectric material selected from a group comprising Al₂O₃, Fe₂O₃, HfO₂, MgF₂, SiO₂, Ta₂O₅, TiO₂, ZnO, ZnS and ZnSe.

7. The system of claim 4, wherein the at least one predicted material includes a light absorbing material selected from a group comprising inorganic compounds and organic compounds.

8. The system of claim 1, wherein the multitask neural network includes:
a classification network configured to determine the at least one predicted material; and
a mixture density network configured to determine the predicted structural parameter distribution.

9. The system of claim 8, wherein training the multitask neural network includes training the classification network together with the mixture density network.

10. The system of claim 1, wherein:
the at least one target optical perception parameter or target optical response is selected from an optical parameter space; and
the instructions further include generating the material feature vector inputs by uniformly sampling the optical parameter space.

11. The system of claim 1, wherein the instructions further include generating at least one of the material feature vector inputs to include a synthetic material generated according to material structural parameters of at least two of the material data structures.

12. The system of claim 1, wherein the tuned structural parameter output includes at least one of a material thickness, a diameter, a distance, a periodic pattern, a pitch, and a material shape.

13. The system of claim 1, wherein the at least one target optical perception parameter or target optical response includes one or a filtering characteristic of an optical structure and a light absorption characteristic of an optical structure.

14. A method for generating optical structure material parameters, the method comprising:
training a multitask neural network with material feature vector inputs to generate a material structural parameter output, wherein each material feature vector input includes at least one material structural parameter associated with at least one of an optical perception output and an optical response output, a material database includes multiple material data structures each including one or more material structural parameters, and the material structural parameter output includes at least one predicted material and a predicted structural parameter distribution of the at least one predicted material;
obtaining at least one of a target optical perception parameter and a target optical response;
supplying the at least one target optical perception parameter or target optical response and at least two of the multiple material data structures of the material database to the multitask neural network to output the at least one predicted material and the predicted structural parameter distribution for generating the at least one target optical perception parameter or target optical response;
processing, by an optimization model, the predicted structural parameter distribution to generate a tuned structural parameter output for generating the at least one target optical perception parameter or target optical response; and
transmitting the at least one predicted material and the tuned structural parameter output to a computing device to facilitate generation of an optical structure including the at least one predicted material having the tuned structural parameter output.

15. The method of claim 14, wherein the optimization model is a particle swarm optimization model.

16. The method of claim 14, wherein the optical structure includes at least one of a multilayer thin film, a metasurface and self-assembled colloidal particles.

17. The method of claim 14, wherein:
the optical structure includes a multilayer thin film; and
the predicted structural parameter distribution includes a thickness distribution of at least one layer of the multilayer thin film.

18. The method of claim 17, wherein:
the at least one target optical perception parameter or target optical response includes a visual color;
the multilayer thin film includes at least one first dielectric material and at least one second dielectric material having a different refractive index than the first dielectric material; and
the at least one predicted material includes a dielectric material selected from a group comprising Si, Ge, Al₂O₃, Fe₂O₃, HfO₂, MgF₂, SiO₂, Ta₂O₅, TiO₂, ZnO, ZnS and ZnSe.

19. The method of claim 17, wherein:
the at least one target optical perception parameter or target optical response includes a visual color;
the multilayer thin film includes at least one metal material and at least one dielectric material; and
the at least one predicted material includes a metal material selected from a group comprising Au, Ag, Al, Cu, Cr, Ge, Ni, Ti, W and Zn, and a dielectric material selected from a group comprising Al₂O₃, Fe₂O₃, HfO₂, MgF₂, SiO₂, Ta₂O₅, TiO₂, ZnO, ZnS and ZnSe.

20. The method of claim 17, wherein the at least one predicted material includes a light absorbing material selected from a group comprising inorganic compounds and organic compounds.

21. The method of claim 14, wherein the multitask neural network includes:
a classification network configured to determine the at least one predicted material; and
a mixture density network configured to determine the predicted structural parameter distribution.

22. The method of claim 21, wherein training the multitask neural network includes training the classification network together with the mixture density network.

23. The method of claim 14, wherein:
the at least one target optical perception parameter or target optical response is selected from an optical parameter space; and
the method further includes generating the material feature vector inputs by uniformly sampling the optical parameter space.

24. The method of claim 14, wherein the method further includes generating at least one of the material feature vector inputs to include a synthetic material generated according to material structural parameters of at least two of the material data structures.
